(19) United States
(12) Patent Application Publication
(10) Pub. No.: US 2014/0085149 A1
(43) Pub. Date: Mar. 27, 2014

(54) ANTENNA-INTEGRATED ISOLATION COVER AND ELECTRONIC APPARATUS

(71) Applicant: ASKEY COMPUTER CORP., New Taipei City (TW)

(72) Inventor: Chun-Wen CHO, Guishan Township (TW)

(73) Assignee: ASKEY COMPUTER CORP., NEW TAIPEI CITY (TW)

(21) Appl. No.: 13/692,770

(22) Filed: Dec. 3, 2012

(30) Foreign Application Priority Data
Sep. 26, 2012 (TW) 101135380

(51) Int. Cl. H01Q 1/22

(52) U.S. Cl. CPC H01Q 1/22
USPC 343/702

(57) ABSTRACT

An antenna-integrated isolation cover comprises a main body, a first antenna unit, and a plurality of holes. The main body has a first side. The first antenna unit is disposed on the first side of the main body. The holes are disposed to the main body. An electronic apparatus using the antenna-integrated isolation cover is also disclosed.

### CROSS REFERENCE TO RELATED APPLICATIONS

This Non-provisional application claims priority under 35 U.S.C. §119(a) on Patent Application No(s). 101135380 filed in Taiwan, Republic of China on Sep. 26, 2012, the entire contents of which are hereby incorporated by reference.

### BACKGROUND OF THE INVENTION

1. Field of Invention

The invention relates to an isolation cover and, in particular, to an antenna-integrated isolation cover and an electronic apparatus using the isolation cover.

2. Related Art

For the sake of user's health, the consumer protection organizations of different countries have established the related security regulation for the wireless communication electronic apparatus, such as a cell phone or a tablet computer, to protect the human body from the harm caused by the electromagnetic interference (EMI). Hence, the electronic apparatus that can not pass the safety certification will not be sold. Therefore, many electronic apparatuses are equipped with various consumer protection mechanisms, one of which is an isolation cover. The isolation cover is usually made of metal for effectively isolating the electromagnetic waves generated during the operation of the electronic devices that are disposed inside the electronic apparatus. Furthermore, the isolation cover also can prevent the user from contacting the inner electronic devices so as to achieve the security purpose.

The electronic apparatus capable of wireless communication needs to be configured with an antenna to receive or transmit electromagnetic signals. In general, the antenna is made of metal, and for providing the more effective radiation, it's usually disposed in a cleared area of a printed circuit board (PCB) for reducing the interference caused by other electronic devices. Besides, the certification procedure is essential to make sure the antenna assembly is correct during the manufacturing process.

In the conventional technology, the isolation cover and the antenna are manufactured separately, causing the more cost and manufacturing time. Therefore, it is an important subject to provide an isolation cover, especially an antenna-integrated isolation cover that can reduce the production cost and time and also decease the certification time.

### SUMMARY OF THE INVENTION

In view of the foregoing subject, the invention provides an antenna-integrated isolation cover, which comprises a main body, a first antenna unit, and a plurality of holes. The main body comprises a first side. The first antenna unit is disposed on the first side of the main body. The holes are disposed to the main body.

In view of the foregoing subject, the invention provides an electronic apparatus, which comprises an apparatus body and an isolation cover. The apparatus body comprises a circuit board, which comprises a first feed point. The isolation cover is disposed to the apparatus body and coupled with the circuit board. The isolation cover comprises a main body, a first antenna unit, and a plurality of holes. The first antenna unit is disposed on a first side of the main body, and comprises a first protrusion coupled with the first feed point. The holes are disposed to the main body.

In one embodiment, the first antenna unit has at least a bent portion.

In one embodiment, the isolation cover further comprises a second antenna unit disposed on a second side of the main body.

In one embodiment, the second antenna unit has at least a bent portion.

In one embodiment, the first antenna unit has a first length, the second antenna unit has a second length, and the first length is different from or equal to the second length.

In one embodiment, the second antenna unit has a second protrusion, the circuit board has a second feed point, and the second protrusion is coupled with the second feed point.

In one embodiment, the isolation cover further comprises a resonance absorbing unit disposed on a third side of the main body.

In one embodiment, the resonance absorbing unit has at least a bent portion.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic diagram of an antenna-integrated isolation cover of a preferred embodiment of the invention;

FIG. 1B is a schematic diagram of an antenna-integrated isolation cover of another preferred embodiment of the invention;

FIG. 2A is a schematic diagram of an antenna-integrated isolation cover of another preferred embodiment of the invention;

FIG. 2B is a schematic diagram of an antenna-integrated isolation cover of another preferred embodiment of the invention; and

FIG. 3 is a schematic diagram of an electronic apparatus of a preferred embodiment of the invention.

### DETAILED DESCRIPTION OF THE INVENTION

The present invention will be apparent from the following detailed description, which proceeds with reference to the accompanying drawings, wherein the same references relate to the same elements.

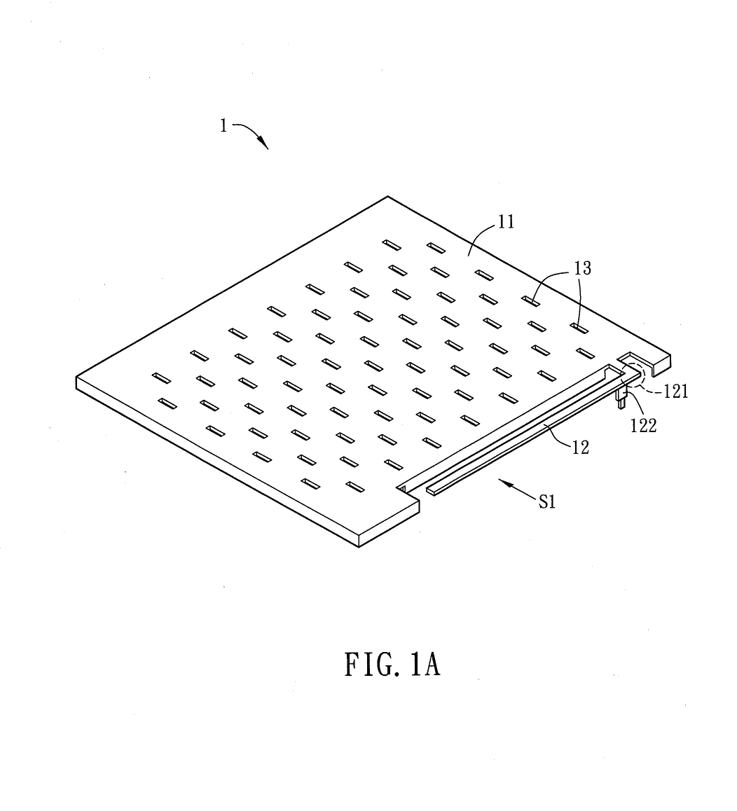

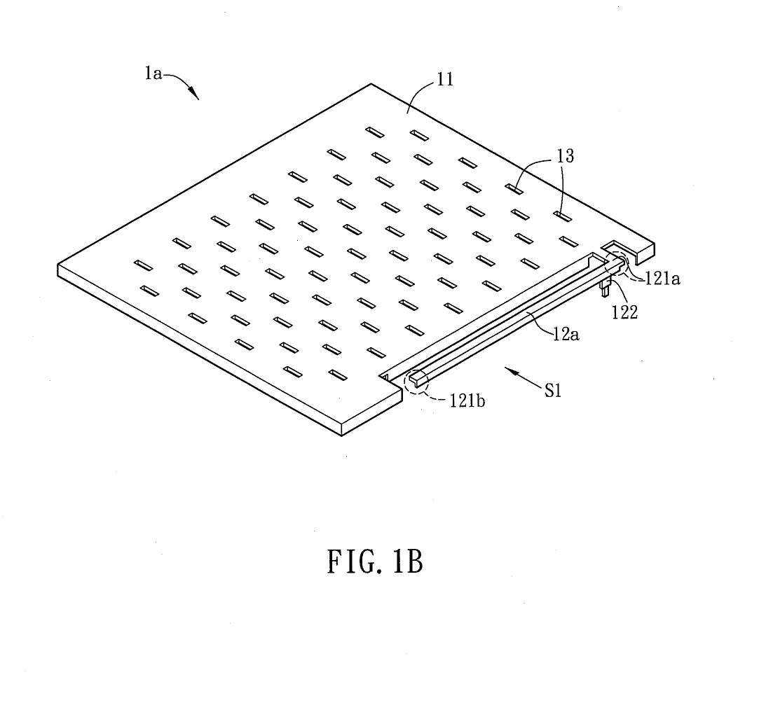

FIG. 1A is a schematic diagram of an antenna-integrated isolation cover of a preferred embodiment of the invention. Referring to FIG. 1A, the isolation cover 1 includes a main body 11, a first antenna unit 12, and a plurality of holes 13.

The main body 11 has a first side S1. The main body 11 is the main structure of the isolation cover 1. The material of the main body 11 is iron, aluminum alloy, magnesium-aluminum alloy, or other metal or alloy. In this embodiment, the main body 11 is shaped like a rectangle for example. In other embodiments, the main body 11 can be shaped otherwise according to the practical requirements.

The first antenna unit 12 is disposed on the first side S1 of the main body 11. The material of the first antenna unit 12 is iron, aluminum alloy, magnesium-aluminum alloy, or other metal or alloy. The first antenna unit 12 and the main body 11 can be integrally formed as one piece, or they can be made separately and then assembled by soldering or conductive adhesive. In this embodiment, the first antenna unit 12 and the main body 11 are integrally formed as one piece by stamping. Accordingly, the first antenna unit 12 and the main body 11 have the same material. Of course, if they are made separately and then assembled by soldering or conductive adhesive, they can have different material.

In this embodiment, the first antenna unit 12 has a bent portion 121 and a first protrusion 122. The bent portion 121 is parallel with the plane that the main body 11 is disposed on so that an interval is formed between the first antenna unit 12 and the main body 11. The first protrusion 122 functions as a feed end of the first antenna unit 12, protruding from the first antenna unit 12. The bent portion 121, the first protrusion 122, and the first antenna unit 12 are integrally formed as one piece by stamping, for example. Of course, they can be made separately and then assembled together in other embodiments.

The holes 13 formed in the main body 11 can be disposed regularly or randomly. In this embodiment, each of the holes 13 is shaped like a strip, and the longer side thereof is perpendicular to the extending direction of the first antenna unit 12. Besides, the greatest interval between the adjacent holes 13 is, for example, less than a quarter of the length of the first antenna unit 12. To be noted, in other embodiments, the hole's shape and dimensions, and the greatest interval between the adjacent holes can be varied according to practical requirements. For example, the hole can be shaped like an ellipse, the length of the hole is 3 mm, and the greatest interval between the adjacent holes is a half of the length of the first antenna unit.

FIG. 1B is a schematic diagram of an antenna-integrated isolation cover of another preferred embodiment of the invention. Referring to FIG. 1B, the isolation cover 1a is approximately the same as the isolation cover 1, so only the different portion thereof is illustrated in the following descriptions, and the common portion thereof is omitted.

The difference between the isolation covers 1a and 1 is that the first antenna unit 12a has two bent portions 121a and 121b. The bent portion 121a is parallel with the plane that the main body 11 is located on, and the bent portion 121b and the plane have an included angle so as to enhance the rigidity of the first antenna unit 12a. In other words, the first antenna unit 12a of this embodiment has higher rigidity than the first antenna unit 12.

To be noted, the number, angle, and direction of the bent portions can be varied according to the practical requirements in different embodiments.

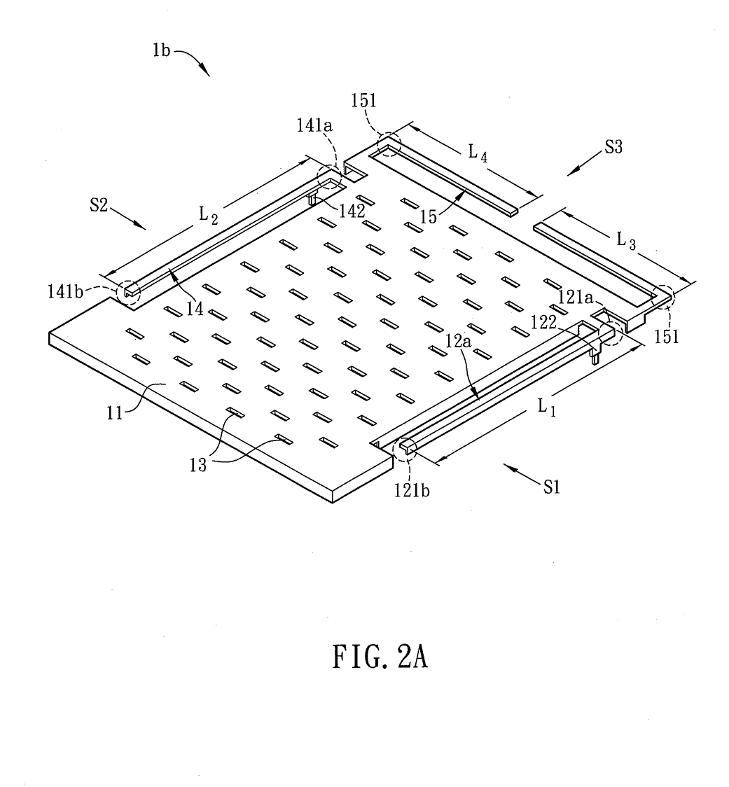

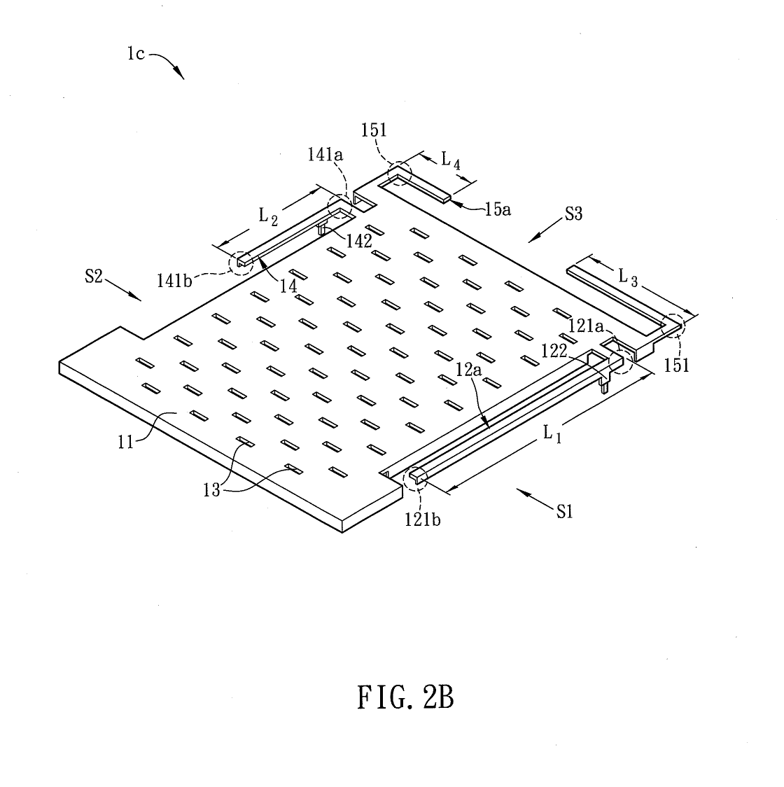

FIG. 2A is a schematic diagram of an antenna-integrated isolation cover of another preferred embodiment of the invention. Referring to FIG. 2A, the isolation cover 1b is approximately the same as the isolation cover 1a, so only the different portion thereof is illustrated in the following descriptions, and the common portion thereof is omitted.

The difference between the isolation covers 1b and 1a is that the isolation cover 1b further includes a second antenna unit 14 and a resonance absorbing unit15.

The second antenna unit 14 is disposed on a second side S2 of the main body 11. In this embodiment, the second side S2 is opposite to the first side S1 so that the mutual interference between the first and second antenna units 12a and 14 can be reduced.

Similar to the first antenna unit 12a, the second antenna unit 14 can have at least a bent portion. Herein, the second antenna unit 14 has two bent portions 141a and 141b. The bent portion 141a is parallel with the plane that the main body 11 is located on, and the bent portion 141b and the plane have an included angle so as to enhance the rigidity of the second antenna unit 14. The second antenna unit 14 also has a second protrusion 142 protruding from the second antenna unit 14 for functioning as a feed end of the second antenna unit 14.

In this embodiment, the first antenna unit 12a has a first length L1, the second antenna unit 14 has a second length L2, and the first length L1 is equal to the second length L2. In other words, the first and second antenna units 12a and 14 have the same operating frequency band so as to improve the quality of receiving and transmitting the electromagnetic signals.

The resonance absorbing unit 15 is disposed on a third side S3 of the main body 11. The third side S3 is different from the sides of the first and second antenna units 12a and 14, and for example, is adjacent to the first side S1. The resonance absorbing unit 15 is for reducing the mutual interference between the first and second antenna units 12a and 14. The resonance absorbing unit 15 has a third length L3 and a fourth length L4. Preferably, the third length L3 is a half or quarter of the first length L1. In this embodiment, the third length L3 is a half of the first length L1, and the fourth length L4 is equal to the third length L3. In addition, the resonance absorbing unit 15 can have at least a bent portion 151.

FIG. 2B is a schematic diagram of an antenna-integrated isolation cover of another preferred embodiment of the invention. Referring to FIG. 2B, the isolation cover 1c is approximately the same as the isolation cover 1b, so only the different portion thereof is illustrated in the following descriptions, and the common portion thereof is omitted.

The difference between the isolation covers 1c and 1b is that the first length L1 of the first antenna unit 12a is different from the second length L2 of the second antenna unit 14a. The third length L3 of the resonance absorbing unit 15a is a half of the first length L1 of the first antenna unit 12a, and the fourth length L4 of the resonance absorbing unit 15a is equal to a half of the second length L2 of the second antenna unit 14a.

In other words, the first and second antenna units 12a and 14a operate in different operating frequency bands so that the isolation cover 1c can have multiple operating frequency bands for receiving and transmitting the electromagnetic signals.

To deserve to be mentioned, in this embodiment, the holes 13 also can reduce the mutual interference between the first and second antenna units 12a and 14a.

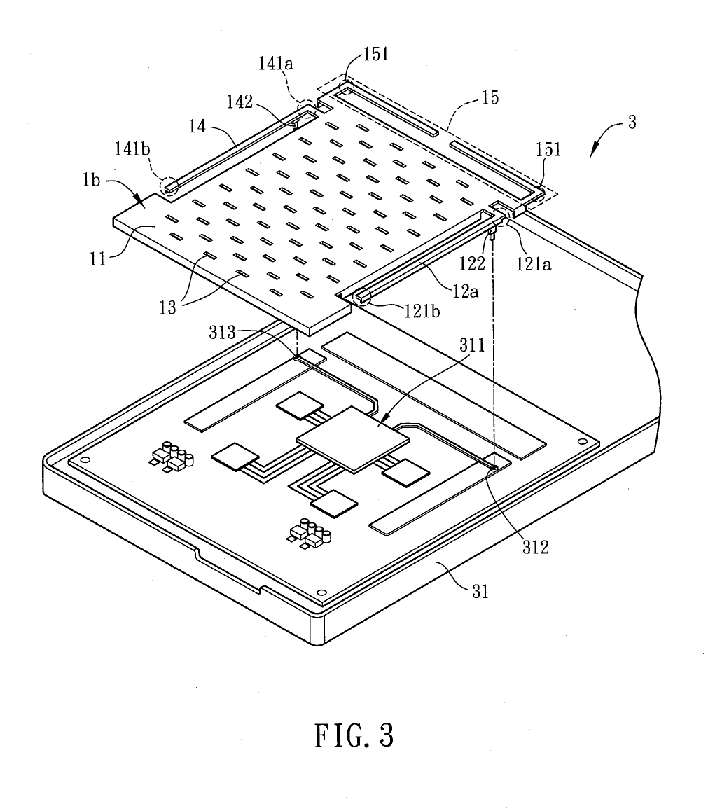

FIG. 3 is a schematic diagram of an electronic apparatus of a preferred embodiment of the invention. Referring to FIG. 3, the electronic apparatus 3 can be a cell phone, a tablet computer, or other apparatuses capable of wireless communication. The electronic apparatus 3 includes an apparatus body 31 and an isolation cover 1b.

The apparatus body 31 has a circuit board 311. The circuit board is, for example, a primary circuit board including an integration of a central processing unit (CPU) and other chips or circuits. The circuit board 311 has at least a feed point. In this embodiment, the circuit board 311 has two feed points, which are a first feed point 312 and a second feed point 313.

The isolation cover can have the same technical features of the isolation cover 1, 1a, 1b or 1c illustrated as above, so the detailed descriptions are omitted here. The following descriptions are given by taking the isolation cover lb as an example, including the relation between the isolation cover lb and the apparatus body 31.

The isolation cover 11b includes a main body 11, a first antenna unit 12a, a plurality of holes 13, a second antenna unit 14, and a resonance absorbing unit 15.

The isolation cover 1b is disposed to the apparatus body 31 and coupled with the circuit board 311. The isolation cover 1b is disposed to the apparatus body 31 by soldering for example, for isolating the noise or electromagnetic wave emitted by the circuit board 311.

Specifically, the first antenna unit 12a is coupled with the circuit board 311 through the first protrusion 122, and the second antenna unit 14 is coupled with the circuit board 311 through the second protrusion 142. More specifically, the first protrusion 122 is coupled with the first feed point 312, and the second protrusion 142 is coupled with the second feed point 313.

For instance, when the electronic apparatus 3 transmits signals, the circuit board 311 feeds the first antenna unit 12a through the first feed point 312 and the first protrusion 122, or feeds the second antenna unit 14 through the second feed point 313 and the second protrusion 142. Then, the first antenna unit 12a or the second antenna unit 14 transmits the signals in the electromagnetic wave form. When the electronic apparatus 3 receives electromagnetic wave signals, the electromagnetic wave signals are received first by the first antenna unit 12a or the second antenna unit 14, and then delivered to the circuit board 311 through the first protrusion 122 and the first feed point 312 or through the second protrusion 142 and the second feed point 313.

To deserve to be mentioned, besides reducing the mutual interference between the first and second antenna units 12a and 14, the holes 13 also can dissipate the heat.

In summary, the first antenna unit is integrated with the isolation cover's main body in the invention, thereby decreasing the production cost and time and besides reducing the certification time. Furthermore, when the first and second antenna units are integrated with the isolation cover, the isolation cover can have better quality of receiving and transmitting electromagnetic wave signals. In addition, the lengths of the first and second antenna units can be varied and designed so as to achieving multiple operating frequency bands.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An antenna-integrated isolation cover, comprising:
a main body comprising a first side;
a first antenna unit disposed on the first side of the main body; and
a plurality of holes disposed to the main body.

2. The isolation cover as recited in claim 1, wherein the first antenna unit has at least a bent portion.

3. The isolation cover as recited in claim 1, wherein the first antenna unit has a first protrusion.

4. The isolation cover as recited in claim 1, further comprising:
a second antenna unit disposed on a second side of the main body that is opposite to the first side of the main body.

5. The isolation cover as recited in claim 4, wherein the second antenna unit has at least a bent portion.

6. The isolation cover as recited in claim 4, wherein the first antenna unit has a first length, the second antenna unit has a second length, and the first length is different from or equal to the second length.

7. The isolation cover as recited in claim 4, wherein the second antenna unit has a second protrusion.

8. The isolation cover as recited in claim 1, further comprising:
a resonance absorbing unit disposed on a third side of the main body that is adjacent to the first side of the main body.

9. The isolation cover as recited in claim 8, wherein the resonance absorbing unit has at least a bent portion.

10. An electronic apparatus, comprising:
an apparatus body comprising a circuit board that comprises a first feed point; and
an isolation cover disposed to the apparatus body and comprising a main body, a first antenna unit and a plurality of holes, wherein the first antenna unit is disposed on a first side of the main body, and comprises a first protrusion coupled with the first feed point, and the holes are disposed to the main body.

11. The electronic apparatus as recited in claim 10, wherein the first antenna unit has at least a bent portion.

12. The electronic apparatus as recited in claim 10, wherein the isolation cover further comprises a second antenna unit disposed on a second side of the main body that is opposite to the first side of the main body.

13. The electronic apparatus as recited in claim 12, wherein the second antenna unit has at least a bent portion.

14. The electronic apparatus as recited in claim 12, wherein the first antenna unit has a first length, the second antenna unit has a second length, and the first length is different from or equal to the second length.

15. The electronic apparatus as recited in claim 12, wherein the second antenna unit has a second protrusion, the circuit board has a second feed point, and the second protrusion is coupled with the second feed point.

16. The electronic apparatus as recited in claim 10, wherein the isolation cover further comprises a resonance absorbing unit disposed on a third side of the main body that is adjacent to the first side of the main body.

17. The electronic apparatus as recited in claim 16, wherein the resonance absorbing unit has at least a bent portion.
